(19) United States
(12) Patent Application Publication
(10) Pub. No.: US 2024/0413504 A1
(43) Pub. Date: Dec. 12, 2024

(54) POWER STORAGE DEVICE

(71) Applicants: KABUSHIKI KAISHA TOYOTA JIDOSHOKKI, Kariya-shi (JP); TOYOTA JIDOSHA KABUSHIKI KAISHA, Toyota-shi (JP)

(72) Inventors: Ryuji OIDE, Kariya-shi (JP); Kazuki Maeda, Kariya-shi (JP); Satoshi Morioka, Okazaki-shi (JP); Motoyoshi Okumura, Nagoya-shi (JP)

(73) Assignees: KABUSHIKI KAISHA TOYOTA JIDOSHOKKI, Kariya-shi (JP); TOYOTA JIDOSHA KABUSHIKI KAISHA, Toyota-shi (JP)

(21) Appl. No.: 18/331,683

(22) Filed: Jun. 8, 2023

(30) Foreign Application Priority Data
Jun. 10, 2022 (JP) 2022-094670

(51) Int. Cl. H01M 50/593; H01M 10/30; H01M 50/291; H01M 50/567

(52) U.S. Cl. CPC H01M 50/593; H01M 10/30; H01M 50/291; H01M 50/567; H01M 2004/029

(57) ABSTRACT

A power storage device includes a pair of restraint plates configured to sandwich and restrain a stacked body, a pair of current collector plates, and a pair of insulating plates in a first direction; and a terminal base configured to be provided on a side surface of at least one of the restraint plates extending in a third direction intersecting both the first direction and a second direction, and the first direction, and have a terminal bolt fixed thereto. The at least one of the restraint plates is configured to have a pair of projecting portions projecting in the second direction beyond the side surface having the terminal base fixed thereto when viewed in the first direction.

### CROSS-REFERENCE TO RELATED APPLICATIONS

This application claims the benefit of priority from Japanese Patent Application No. 2022-094670, filed on Jun. 10, 2022, the entire content of which is incorporated herein by reference.

### TECHNICAL FIELD

The present disclosure relates to a power storage device.

### BACKGROUND

PCT International Publication No. WO2020/026966 discloses a power storage device. This power storage device includes a plurality of stacked batteries, restraint members sandwiching the plurality of batteries therebetween, and an insulation spacer electrically insulating the plurality of batteries and the restraint members from each other.

### SUMMARY

Generally, in a constitution in which stacked bipolar electrodes are restrained by restraint plates in a stacking direction, in order to electrically insulate the bipolar electrodes and the restraint plates from each other, insulation members can be disposed between the bipolar electrodes and the restraint plates. In such a structure, for example, when a force from the outside is applied to a power storage device in a direction intersecting the stacking direction of the bipolar electrodes, or the like, if the insulation members are damaged, it is conceivable that insulation properties between the bipolar electrodes and the restraint plates deteriorate.

The present disclosure provides a power storage device capable of curbing damage to insulating plates between bipolar electrodes and restraint plates.

A power storage device of the present disclosure includes a stacked body configured to have a power storage module in which electrodes including a plurality of bipolar electrodes are stacked in a first direction; a pair of current collector plates configured to be respectively stacked at both ends of the stacked body in the first direction; a pair of insulating plates configured to sandwich the stacked body and the pair of current collector plates in the first direction; a pair of restraint plates configured to sandwich and restrain the stacked body, the pair of current collector plates, and the pair of insulating plates in the first direction; and a terminal base configured to have a terminal bolt electrically connected to a terminal of at least one of the current collector plates and protruding in a second direction intersecting the first direction fixed thereto, and be provided on a first side surface extending in a third direction intersecting both the first direction and the second direction, and the first direction in at least one of the restraint plates. The at least one of the restraint plates is configured to have a pair of projecting portions projecting in the second direction beyond the first side surface having the terminal base fixed thereto when viewed in the first direction. The terminal base is configured to be disposed between the pair of projecting portions when viewed in the first direction. The at least one of the insulating plates is configured to include a terminal base protection portion covering at least a part of the terminal base. The pair of projecting portions are configured to project beyond the terminal base protection portion in the second direction.

In the foregoing power storage device, the pair of insulating plates are sandwiched by the restraint plates in the first direction. Further, in the second direction, the projecting portions formed in the restraint plate project beyond the terminal base protection portion in the second direction, and this terminal base protection portion covers the terminal base disposed between the pair of projecting portions. Due to such a constitution, an external force applied to the power storage device in the second direction or the third direction is likely to act on the pair of projecting portions. For example, when the power storage device comes into contact with a wall surface or the like by relatively moving in the second direction, only the projecting portions projecting in the second direction come into contact with the wall surface or the like. In this case, damage to the terminal base protection portion of the insulating plate positioned between the pair of projecting portions is curbed. In this manner, in the foregoing power storage device, damage to the insulating plate is curbed.

The at least one of the insulating plates according to an example may be configured to have a peripheral wall standing in the first direction. The peripheral wall may be configured to have a first wall portion standing in a direction lying in the first direction away from the at least one of the restraint plates adjacent thereto in a range having the projecting portions formed therein in the third direction, and a second wall portion standing in a direction opposite to the first wall portion in the first direction in a range between the pair of projecting portions in the third direction. In this constitution, accumulation of a liquid on an inward side of the peripheral wall formed in the insulating plate is curbed.

The first wall portion according to an example may be configured to have a first side wall in the third direction when viewed in the first direction. The pair of projecting portions may be configured to project beyond the first side wall in the second direction. In this constitution, for example, when the power storage device comes into contact with the wall surface or the like by relatively moving in the second direction, only the projecting portions projecting in the second direction come into contact with the wall surface or the like. In this case, damage to the first side wall further recessed than the projecting portions in the second direction is curbed.

The second wall portion according to an example may be configured to have a second side wall covering the first side surface in the third direction when viewed in the first direction. The first side wall may be configured to project beyond the second side wall in the second direction. In this constitution, insulation distances between the current collector plates and the restraint plates can be lengthened as much as the peripheral wall.

The second wall portion according to an example may be configured to have a third side wall in the second direction when viewed in the first direction such that a second side surface in the second direction of the projecting portions is covered. The second side wall and the third side wall may be configured to be connected to each other and cover the first side surface and the second side surface of the at least one of the restraint plates.

### BRIEF DESCRIPTION OF THE DRAWINGS

FIG. 1 is a schematic view of a power storage device according to an example.

FIG. 2 is an exploded perspective view illustrating a constitution of an end portion on one side in a Y axis direction in the power storage device according to the example.

FIG. 3 is a perspective view illustrating a state where a terminal cover is mounted in the power storage device according to the example.

FIG. 4 is a perspective view illustrating a part in the vicinity of a terminal base in the power storage device according to the example.

FIG. 5 is an explanatory view of a constitution of an end portion on the other side in the Y axis direction in the power storage device according to the example.

FIG. 6 is another explanatory view of a constitution of the end portion on the other side in the Y axis direction in the power storage device according to the example.

### DETAILED DESCRIPTION

Hereinafter, an embodiment of the present disclosure will be described in detail with reference to the accompanying drawings. In description of the drawings, the same reference signs are used for elements which are the same or equivalent, and duplicate description will be omitted. In the drawings, an orthogonal coordinate system having an X axis direction, a Y axis direction, and a Z axis direction will be indicated. Hereinafter, the Z axis direction may be described as an upward-downward direction. In addition, one side and the other side in the X axis direction, the Y axis direction, and the Z axis direction may be described as a positive side and a negative side in accordance with the direction of each axis of coordinates.

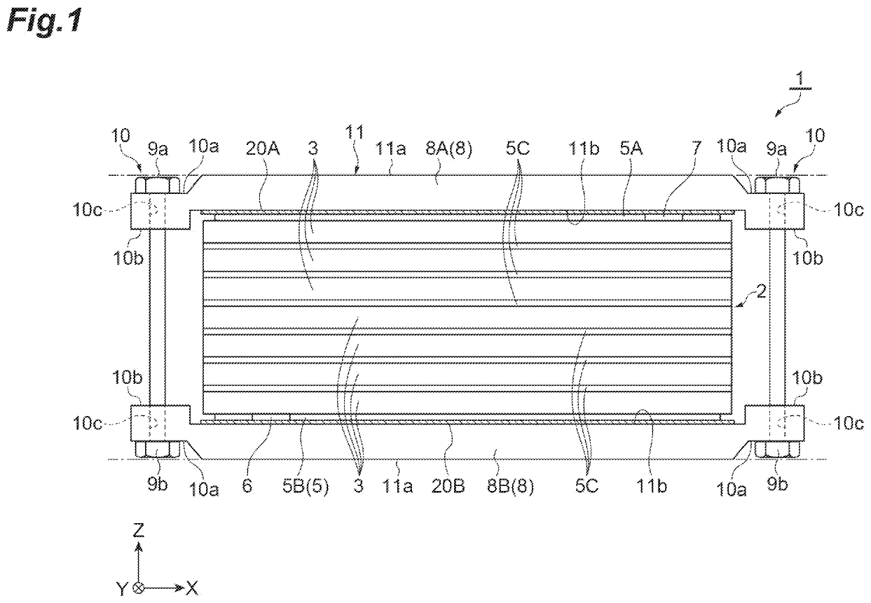

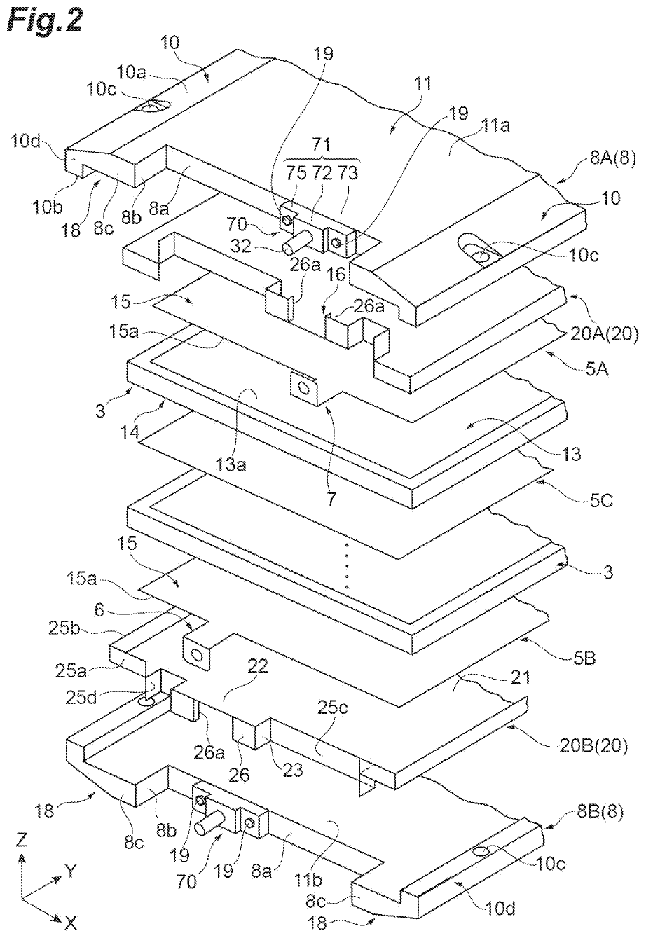

FIG. 1 is a schematic view of a power storage device according to an example. FIG. 2 is an exploded perspective view illustrating a constitution of an end portion in the Y axis direction in the power storage device according to the example. For example, a power storage device 1 is used as a battery for various kinds of vehicles such as a forklift, a hybrid car, and an electric car. The power storage device 1 according to an example includes a stacked body 2 including a plurality of stacked bipolar electrodes, current collector plates 5A and 5B, insulating plates 20A and 20B, restraint plates 8A and 8B, and a terminal base 70. In this specification, for the sake of convenience, a stacking direction of electrodes including the bipolar electrodes is referred to as the Z axis direction, a direction substantially orthogonal to the stacking direction, that is a longitudinal direction of power storage modules 3 viewed in the stacking direction is referred to as the Y axis direction, and a direction substantially orthogonal to the stacking direction, that is a transverse direction of the power storage modules 3 is referred to as the X axis direction. In the present embodiment, the Z axis direction coincides with a vertical direction, the positive side in the Z axis direction coincides with the upper side in the vertical direction, and the negative side in the Z axis direction coincides with the lower side in the vertical direction.

The stacked body 2 according to an example includes a plurality of (seven in the present embodiment) power storage modules 3 and a plurality of (sixth in the present embodiment) conductive plates 5C. The power storage modules 3 are each constituted by stacking a plurality of electrodes including bipolar electrodes. The stacked body 2 is formed by alternately stacking the power storage modules 3 and the conductive plates 5C. The stacked body 2 may have only one power storage module 3. In such a case, the conductive plates 5C are not provided. For example, the power storage modules 3 are secondary batteries such as nickel-hydride secondary batteries or lithium-ion secondary batteries. However, the power storage device 1 is not limited to the foregoing secondary batteries and may be an electric double layer capacitor, for example. In the present embodiment, the power storage device 1 is a nickel-hydride secondary battery.

In the bipolar electrodes of the power storage modules 3, a positive electrode (positive electrode active material layer) is formed on a first surface (for example, a lower surface) that is one surface of an electrode plate, and a negative electrode (negative electrode active material layer) is formed on a second surface (for example, an upper surface) that is the other surface. The power storage modules 3 each include an electrode stacked body 13 constituted by alternately stacking a plurality of bipolar electrodes and a plurality of separators (refer to FIG. 2). In addition, a seal member 14 (seal portion) made of a frame-shaped insulating resin is provided on a side surface of the electrode stacked body 13. That is, the side surface of the electrode stacked body 13 is sealed by the seal member 14. Inside the electrode stacked body 13, an electrolytic solution (electrolyte) is enclosed inside a space defined by the electrodes and the seal member 14 adjacent to each other in the Z axis direction. The power storage modules 3 each include a positive electrode termination electrode and a negative electrode termination electrode respectively having current output surfaces 13a on the positive electrode side and the negative electrode side at both ends in the Z axis direction. The current output surfaces 13a are surfaces outputting a current from each of the power storage modules 3. The current output surfaces 13a are formed by exposing the electrodes of the electrode stacked body 13 from the seal member 14. That is, the positive electrode termination electrode has the electrode plate and the positive electrode provided on the first surface of the electrode plate and forms the current output surface 13a by exposing the second surface of the electrode plate from the seal member 14. In addition, the negative electrode termination electrode has the electrode plate and the negative electrode provided on the second surface of the electrode plate and forms the current output surface 13a by exposing the first surface of the electrode plate from the seal member 14.

A plurality of power storage modules 3 are stacked in the Z axis direction with the conductive plates 5C therebetween. The power storage modules 3 adjacent to each other in the Z axis direction are electrically connected to each other with the conductive plates 5C therebetween. That is, the stacked body 2 is constituted by alternately stacking the power storage modules 3 and the conductive plates 5C. Between the power storage modules 3 adjacent to each other in the Z axis direction, the conductive plates 5C are formed to have a rectangular plate shape and disposed in a contact manner between the current output surfaces 13a of the electrode stacked bodies 13 facing each other.

As illustrated in FIG. 1, the current collector plates 5A and 5B are respectively stacked at one end and the other end that are both ends of the stacked body 2 in the Z axis direction (first direction) that is also the stacking direction of the stacked body 2. That is, a pair of current collector plates 5A and 5B are disposed at positions sandwiching the stacked body 2 therebetween in the Z axis direction that is the stacking direction. The current collector plate 5A according to an example has a main body portion 15 having a rectangular plate shape brought into contact with the current output surface 13a of the electrode stacked body 13 of the power storage module 3 on the negative electrode side positioned at one end of the stacked body 2, and a negative electrode terminal 7 (terminal) having an outer edge portion 15a of the main body portion 15 as a base end and protruding in the Y axis direction. For example, the negative electrode terminal 7 has a plate shape and is formed integrally with the main body portion 15.

The current collector plate 5B has a shape similar to that of the current collector plate 5A. That is, the current collector plate 5B has the main body portion 15 having a rectangular plate shape brought into contact with the current output surface 13a of the electrode stacked body 13 of the power storage module 3 on the positive electrode side positioned at the other end of the stacked body 2, and a positive electrode terminal 6 (terminal) having the outer edge portion 15a of the main body portion 15 as a base end and protruding in the Y axis direction. Charging and discharging of the power storage device 1 are performed through the negative electrode terminal 7 and the positive electrode terminal 6. In an example, the negative electrode terminal 7 is provided at a position closer to the positive side in the X axis direction, and the positive electrode terminal 6 is provided at a position closer to the negative side in the X axis direction. In the following description, the current collector plates 5A and 5B may be referred to as the current collector plates 5.

The restraint plates 8 restrain the stacked body 2 and the current collector plates 5A and 5B in the Z axis direction. The restraint plates 8 are substantially rectangular metal plates having a surface area slightly larger than a surface area of the power storage module 3 viewed in the Z axis direction. The restraint plate 8 has a main body portion 11 overlapping the stacked body 2 when viewed in the Z axis direction, and edge portions 10 extending in the X axis direction from the main body portion 11 and not overlapping the stacked body 2 when viewed in the Z axis direction. In the present embodiment, a pair of edge portions 10 are respectively provided on both sides of the main body portion 11 in the X axis direction. That is, the main body portion 11 is sandwiched between the pair of edge portions 10. The edge portions 10 each have an inner surface 10b directed to an inward side in the Z axis direction, and an outer surface 10a directed to an outward side in the Z axis direction. The main body portion 11 has an inner surface 11b directed to the inward side in the Z axis direction (a side of the power storage modules 3 in the Z axis direction), and an outer surface 11a that is a surface on a side opposite to the inner surface 11b and directed to the outward side in the Z axis direction (a side opposite to the power storage modules 3 in the Z axis direction). The outer surface 10a extends in a manner of being inclined from an end edge of the outer surface 11a to the inward side in the Z axis direction toward the outward side in the X axis direction. The inner surface 10b is positioned on the inward side in the Z axis direction from the inner surface 11b.

The pair of edge portions 10 are outer edge parts extending in the longitudinal direction (Y axis direction) of the restraint plates 8. The pair of edge portions 10 are disposed such that they do not overlap the stacked body 2 when viewed in the Z axis direction. Each of the edge portions 10 is provided with a plurality of insertion holes 10c through which a bolt 9a is inserted. As illustrated in FIG. 2, the insertion holes 10c according to an example are respectively provided in notch parts in which the outer surfaces 10a are formed along an XY plane. In each of the edge portions 10, the plurality of insertion holes 10c are disposed such that they are separated from each other in the longitudinal direction (Y axis direction) of the restraint plates 8. In the present embodiment, the plurality of insertion holes 10c are disposed with an equal interval therebetween from one end to the other end of the edge portion 10 in the longitudinal direction of the restraint plates 8. In the illustrated example, a protruding portion 10d protruding to the inward side in the Z axis direction is formed at an outer end edge of the edge portion 10 in the X axis direction. The plurality of insertion holes 10c penetrate the protruding portion 10d.

A head portion of the bolt 9a is disposed on the outer surface 10a of the restraint plate 8A. A tip portion (screw tip) of a shaft portion of the bolt 9a protrudes from the outer surface 10a of the restraint plate 8B. A nut 9b is screwed to the tip portion of the bolt 9a. The nut 9b is disposed on the outer surface 10a of the restraint plate 8B. Accordingly, the plurality of power storage modules 3, the plurality of conductive plates 5C, and the current collector plates 5A and 5B are sandwiched between the restraint plates 8A and 8B. In addition, a restraint load in the Z axis direction is applied to the stacked body 2.

In addition, the restraint plate 8 has projecting portions 18. The projecting portions 18 are parts projecting in the Y axis direction beyond a side surface 8a (first side surface) of the main body portion 11. That is, the projecting portions 18 protrude outward in the Y axis direction when viewed in the Z axis direction. The side surface 8a extends in the X axis direction (third direction) and the Z axis direction in the main body portion 11 of the restraint plate 8 and is a surface where the terminal base 70 can be installed as will be described below. The projecting portions 18 according to an example are formed at both ends in the X axis direction on the side surface 8a of the main body portion 11 and at positions including a range having the edge portions 10 formed therein. The projecting portions 18 in the illustrated example are formed up to positions over the edge portions 10 from both end edges of the restraint plates 8 in the X axis direction. The pair of projecting portions 18 respectively have side surfaces 8b (second side surfaces) facing each other in the X axis direction. In addition, the pair of projecting portions 18 have side surfaces 8c (third side surfaces) parallel to the side surface 8a. The side surfaces 8c are end surfaces in the Y axis direction.

The insulating plates 20A and 20B electrically insulate the restraint plates 8 and the current collector plates 5A and 5B from each other. The insulating plate 20A is provided between the current collector plate 5A and the restraint plate 8A. The insulating plate 20A is a member for securing insulation properties between the current collector plate 5A and the restraint plate 8A. For example, the insulating plate 20A is formed of a resin having insulation properties. In addition, the insulating plate 20B is provided between the current collector plate 5B and the restraint plate 8B. The insulating plate 20B is a member for securing insulation properties between the current collector plate 5B and the restraint plate 8B. For example, the insulating plate 20B is formed of a resin having insulation properties.

The terminal base 70 is provided on the side surface 8a that is a terminal base installation surface of the restraint plate 8. The terminal base 70 is disposed between the pair of projecting portions 18 when viewed in the Z axis direction. In the power storage device 1 according to the example, the terminal base 70 is provided in each of the restraint plates 8A and 8B in a similar manner. The negative electrode terminal 7 of the current collector plate 5A is fixed to the terminal base 70 provided in the restraint plate 8A. The positive electrode terminal 6 of the current collector plate 5B is fixed to the terminal base 70 provided in the restraint plate 8B. The terminal base 70 according to an example has a pedestal portion 71 having substantially a rectangular parallelepiped shape of which the longitudinal direction is the X axis direction. For example, the pedestal portion 71 is formed of a resin having insulation properties. In the pedestal portion 71 in the illustrated example, the size in the Y axis direction in parts on both end sides in the X axis direction is smaller than the size in the Y axis direction in a central part in the X axis direction. That is, the pedestal portion 71 includes a central portion 72 protruding in the Y axis direction at the center in the X axis direction, and a pair of end portions 73 and 75 further recessed in the Y axis direction on both end sides in the X axis direction than the central portion 72. A terminal bolt 32 protruding in the Z axis direction is provided in the central portion 72 of the pedestal portion 71.

The pedestal portion 71 of the terminal base 70 is fixed to the side surface 8a of the restraint plate 8 using fixing bolts 19. In an example, penetration holes penetrating the terminal base 70 in the Y axis direction are respectively formed in the pair of end portions 73 and 75 constituting the pedestal portion 71. The pedestal portion 71 is fixed to the side surface 8a when the fixing bolts 19 inserted through the penetration holes are fastened to the side surface 8a of the restraint plate 8A. The pedestal portion 71 protrudes to the negative side in the Y axis direction beyond at least the power storage module 3.

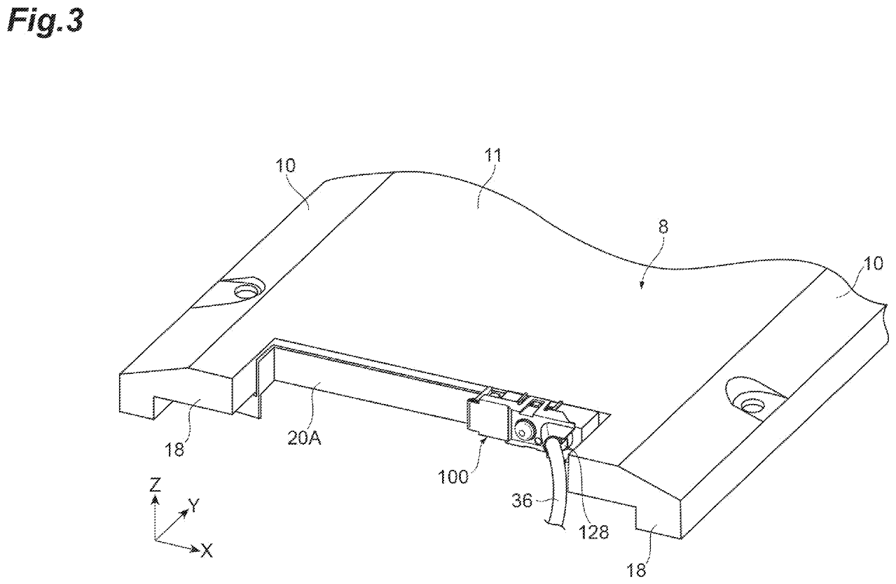

FIG. 3 is a perspective view illustrating a state where a terminal cover is mounted in the power storage device according to the example. FIG. 3 illustrates a terminal cover 100 mounted in the terminal base 70 on the negative electrode terminal 7 side. However, the terminal cover 100 may be mounted in the terminal base 70 on the positive electrode terminal 6 side in a similar manner. As illustrated in FIG. 3, the terminal cover 100 covering the negative electrode terminal 7 and the terminal bolt 32 may be mounted in the terminal base 70 of the power storage device 1. A wiring 36 connected to the terminal bolt 32 is held by the terminal cover 100 in the Y axis direction that is an axial direction of the terminal bolt 32. In an example, the terminal cover 100 may include an opening 128 for guiding the wiring 36 connected to the terminal bolt 32 to the outside. When the wiring 36 is held in the Y axis direction, the wiring 36 need only be held in a state of intersecting an XZ plane, and there is no need for an extending direction of the wiring 36 to completely coincide with the Y axis direction.

The terminal cover 100 according to an example is formed of a resin. For example, a resin constituting the terminal cover 100 may have a tolerance to an electrolytic solution in the power storage modules 3. When the power storage modules 3 are nickel-hydride secondary batteries, examples of a material of a resin include polyethylene and polypropylene.

The terminal cover 100 is attached to the terminal base 70 disposed between the pair of projecting portions 18 when viewed in the Z axis direction. Since the terminal cover 100 covers the terminal base 70, the terminal base 70 is not depicted in FIG. 3. The terminal cover 100 may be disposed in a manner of being biased to a side of one projecting portion 18 between the pair of projecting portions 18. In an example, since the negative electrode terminal 7 is provided at a position closer to the positive side in the X axis direction, the terminal cover 100 mounted in the negative electrode terminal 7 is disposed close to the projecting portion 18 provided on the positive side in the X axis direction. For example, the distance between the terminal cover 100 and the projecting portion 18 may be smaller than the diameter of the wiring 36. In addition, the terminal cover 100 and the projecting portion 18 may come into contact with each other.

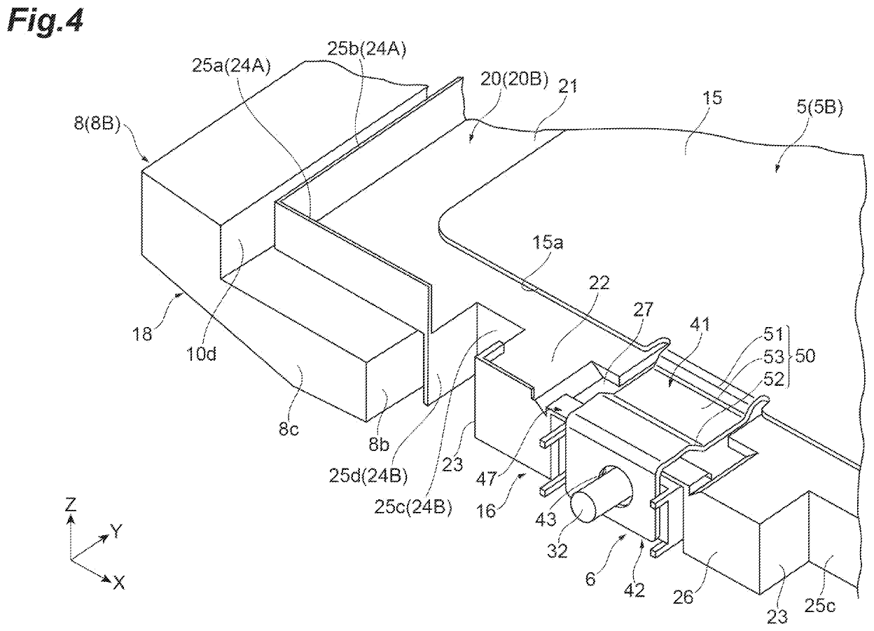

FIG. 4 is an explanatory view of a structure in the vicinity of a terminal base in the power storage device according to the example. FIG. 4 illustrates a part in the vicinity of the terminal base on the positive electrode side in the power storage device 1. FIG. 4 illustrates a state where the terminal cover 100 is detached from the power storage device 1. In the power storage device 1 according to the example, a part in the vicinity of the negative electrode terminal also has a similar constitution.

As illustrated in FIG. 4, the positive electrode terminal 6 has a first piece portion 41, a second piece portion 42, and a bent portion 47, thereby constituting substantially an L-shape when viewed in the X axis direction. The first piece portion 41 is a plate-shaped part extending in the Y axis direction from the outer edge portion 15a that is an edge of the main body portion 15 when viewed in the Z axis direction. The second piece portion 42 is a plate-shaped part bent in the stacking direction toward the terminal base 70 side (the positive side in the Z axis direction) from the tip portion of the first piece portion 41 and attached to the terminal base 70. A penetration hole 43 penetrating the second piece portion 42 in the Y axis direction is formed at a substantially center position thereof. The terminal bolt 32 is inserted through the penetration hole 43.

The terminal bolt 32 protrudes in the Y axis direction from an end surface of the central portion 72 in the pedestal portion 71 (refer to FIG. 2). A tip of the terminal bolt 32 in the Y axis direction may be positioned on the negative side in the Y axis direction from the side surfaces 8c of the projecting portions 18, for example. The terminal bolt 32 extends parallel to the Y axis direction toward the negative side in the Y axis direction. The second piece portion 42 of the positive electrode terminal 6 and a connection terminal connected to the wiring 36 are attached to this terminal bolt 32 in a form of being pressurized to a nut (not illustrated) fastened to the terminal bolt 32.

Both the first piece portion 41 and the second piece portion 42 extend parallel to the X axis direction, and the sizes of both piece portions in the X axis direction are the same. The bent portion 47 is a part connecting the first piece portion 41 and the second piece portion 42 to each other. The bent portion 47 is formed by bending a plate material constituting the positive electrode terminal 6.

A spring portion 50 for relaxing stress acting on the positive electrode terminal 6 is formed in the positive electrode terminal 6. This spring portion 50 can relax stress acting on the positive electrode terminal 6 attached to the terminal bolt 32. The spring portion 50 according to an example includes a bending portion 51, an extending portion 53, and a bending portion 52. The bending portion 51 is formed in an end portion of the positive electrode terminal 6 on the positive side in the Y axis direction, that is, a region where the outer edge portion 15a and the positive electrode terminal 6 are connected to each other. The bending portion 51 is a part where the first piece portion 41 is curved to the terminal base 70 side in the Z axis direction. The extending portion 53 is a part extending in the Y axis direction from the bending portion 51. The bending portion 52 is a part where the first piece portion 41 is curved to a side opposite to the bending portion 51 from an end portion of the extending portion 53 on the negative side in the Y axis direction.

The insulating plate 20 has a main body portion 21 and a wall portion 24 (peripheral wall). The main body portion 21 of the insulating plate 20 is a flat plate-shaped part disposed between the main body portion 15 of current collector plates 5 and the main body portion 11 of the restraint plate 8. The main body portion 21 has substantially a rectangular shape of which the longitudinal direction is the Y axis direction.

The wall portion 24 stands toward the positive side or the negative side in the Y axis direction from a peripheral edge of the insulating plate 20. For example, the wall portion 24 includes a first wall portion 24A and a second wall portion 24B. The first wall portion 24A is formed in a range in which the projecting portion 18 is formed in the X axis direction. The first wall portion 24A stands in a direction lying in the Z axis direction away from the restraint plate 8 adjacent thereto. That is, the first wall portion 24A stands toward the positive side in the Z axis direction. In addition, the second wall portion 24B is formed in a range between the pair of projecting portions 18 in the X axis direction. The second wall portion 24B stands in a direction along the side surface 8a of the restraint plate 8 adjacent thereto. That is, the second wall portion 24B stands toward the negative side in the Z axis direction.

The first wall portion 24A includes a side wall 25a (first side wall) in the X axis direction and a side wall 25b in the Y axis direction when viewed in the Z axis direction. The side wall 25a and the side wall 25b are connected to each other at a corner of the main body portion 21. The side wall 25a and the side wall 25b may have heights which are the same as each other in the Z axis direction. In the illustrated example, the side wall 25a and the side wall 25b have heights which are substantially the same as that of a protruding portion 10d in the Z axis direction. The side wall 25a is positioned on the positive side in the Y axis direction from the side surfaces 8c of the projecting portions 18. That is, the projecting portion 18 projects in the Y axis direction beyond the side wall 25a. The side wall 25b is formed along the protruding portion 10d. A gap may be formed between the side wall 25b and the protruding portion 10d.

The second wall portion 24B includes a side wall 25c (second side wall) in the X axis direction and side walls 25d (third side walls) in the Y axis direction when viewed in the Z axis direction. The side wall 25c extends along the side surface 8a of the restraint plate 8 and covers the side surface 8a. The side wall 25c is positioned on the positive side in the Y axis direction from the side wall 25a. The side walls 25d are continuously formed in the side wall 25c at both ends of the side wall 25c in the X axis direction. The side walls 25d are formed along the side surface 8b of the projecting portion 18 and covers a part on the side surface 8b (a region on the positive side in the Y axis direction in the illustrated example). The side walls 25d are positioned on the positive side in the Y axis direction from the side surfaces 8c of the projecting portions 18. The positions of end edges of the side walls 25d on the negative side in the Y axis direction coincide with the position of the side wall 25a.

In an example, a terminal base protection portion 16 covering at least a part of the terminal base 70 and the fixing bolts 19 is formed in the side wall 25c. The terminal base protection portion 16 is provided in a manner of protruding from the side wall 25c to the negative side in the Y axis direction. The terminal base protection portion 16 has a box shape such that the pedestal portion 71 of the terminal base 70 is accommodated therein.

The terminal base protection portion 16 has an upper wall portion 22 extending from the main body portion 21 to the negative side in the Y axis direction, a pair of side wall portions 23 and 23 extending from the side wall 25c to the negative side in the Y axis direction, and end wall portions 26 extending parallel to the side wall 25c in end portions of the upper wall portion 22 and the side wall portions 23 and 23 on the negative side in the Y axis direction. The upper wall portion 22 is disposed such that the terminal base 70 is covered from above. A recessed portion 27 further dented downward than other regions is formed in the upper wall portion 22. When viewed in the Z axis direction, the recessed portion 27 overlaps the spring portion 50 of the positive electrode terminal 6 and accommodates the spring portion 50.

The side wall portions 23 and 23 are disposed such that the terminal base 70 is covered from both sides in the X axis direction. The end wall portions 26 are disposed such that the end portion (end surface) of the terminal base 70 is covered in the Y axis direction. The end wall portions 26 have an opening therebetween such that the central portion 72 is exposed at the position of the central portion 72 of the terminal base 70. In addition, at the position where the opening between the end wall portions 26 is formed, wing wall portions 26a respectively facing the side wall portions 23 are formed (refer to FIG. 2). The fixing bolts 19 fixing the terminal base 70 to the side surface 8a can be accommodated inside a space formed by the side wall portions 23, the upper wall portion 22, the end wall portions 26, and the wing wall portions 26a.

The end wall portions 26 of the terminal base protection portion 16 are positioned on the positive side in the Y axis direction from the side surfaces 8c of the projecting portions 18. In other words, the projecting portions 18 protrude to the negative side in the Y axis direction beyond the terminal base protection portion 16. That is, the projecting portions 18 protrude to the negative side in the Y axis direction beyond the terminal base 70. In an example, the positions of the end wall portions 26 in the Y axis direction may be the same as the position of the side wall 25a. In the illustrated example, at any position in the X axis direction, the insulating plate 20 is positioned on the positive side in the Y axis direction from the side surfaces 8c of the projecting portions 18.

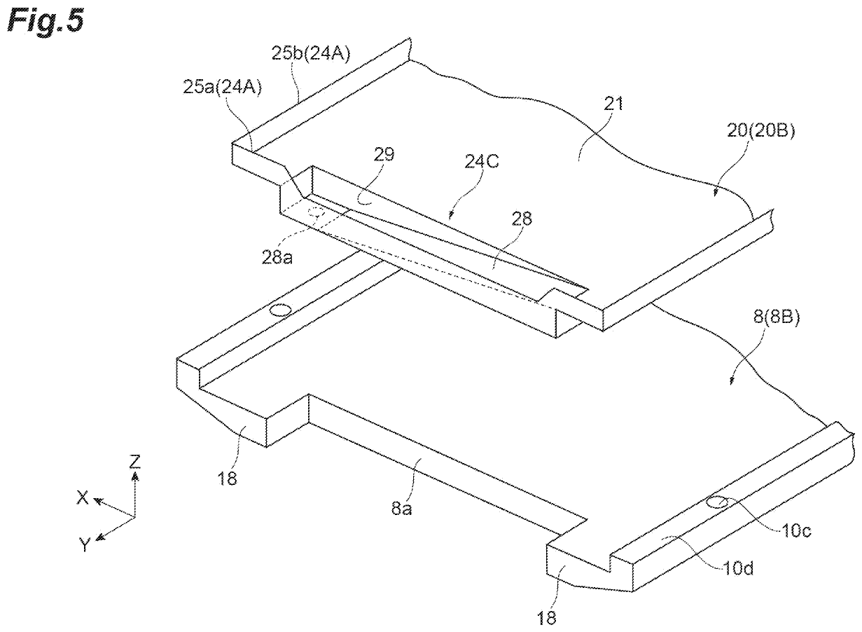

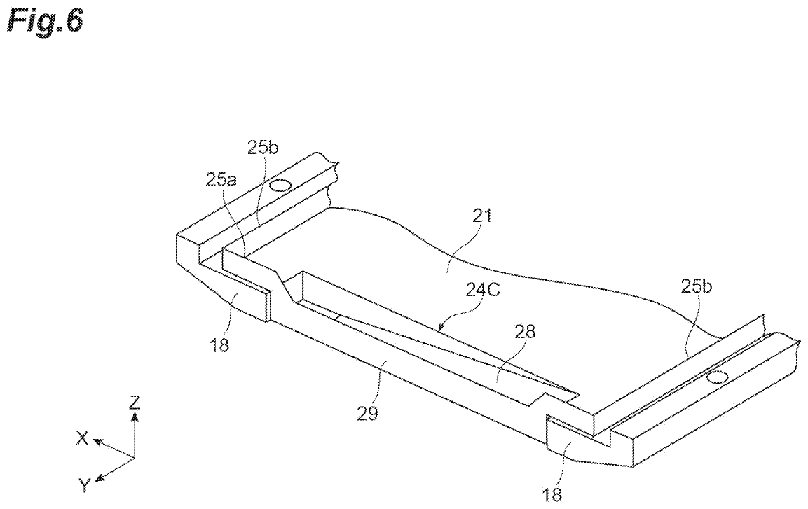

FIG. 5 and FIG. 6 are explanatory views of a constitution of an end portion on the positive side in the Y axis direction in the power storage device according to the example. FIG. 5 is an exploded view of FIG. 6. FIG. 5 and FIG. 6 illustrate only the restraint plate 8 and the insulating plate 20. The restraint plate 8 has the pair of projecting portions 18 on the positive side in the Y axis direction. The constitutions of the pair of projecting portions 18 on the positive side and the negative side in the Y axis direction are similar to each other. However, the restraint plate 8 has no terminal base on the positive side in the Y axis direction. The restraint plate 8 has the side surface 8a along an XZ plane between the pair of projecting portions 18.

Similar to the negative side in the Y axis direction, the insulating plate 20 has the first wall portion 24A in a range in which the projecting portions 18 are formed in the X axis direction. In a range between the pair of projecting portions 18 in the X axis direction, the insulating plate 20 has a liquid receiving portion 24C. The liquid receiving portion 24C is a part for receiving an electrolytic solution discharged from pressure control valves (not illustrated) provided in the power storage modules 3.

The liquid receiving portion 24C has a bottom wall portion 28 and an accommodation side wall portion 29 and is constituted into a recessed shape by the bottom wall portion 28 and the accommodation side wall portion 29. The accommodation side wall portion 29 exhibits a frame shape surrounding the four sides thereof and protrudes to the negative side in the Z axis direction from the main body portion 21 of the insulating plate 20. The bottom wall portion 28 forms a bottom surface of a rectangular space surrounded by the accommodation side wall portion 29. The bottom wall portion 28 in the illustrated example is inclined to the negative side in the Z axis direction as it goes toward the positive side in the X axis direction. The bottom wall portion 28 is provided with a discharge port 28a for discharging a received electrolytic solution to the outside.

The liquid receiving portion 24C is positioned on the negative side in the Y axis direction from the side surfaces 8c of the pair of projecting portions 18. That is, the pair of projecting portions 18 project to the positive side in the Y axis direction beyond the liquid receiving portion 24C. In addition, the liquid receiving portion 24C may be positioned on the positive side in the Z axis direction from the pair of projecting portions 18. That is, the pair of projecting portions 18 project to the negative side in the Z axis direction beyond the liquid receiving portion 24C.

As described above, the power storage device 1 includes the stacked body 2 including a plurality of bipolar electrodes stacked in the Z axis direction; a pair of current collector plates 5 respectively stacked at both ends of the stacked body 2 in the Z axis direction; a pair of insulating plates 20 sandwiching the stacked body 2 and the pair of current collector plates 5 in the Z axis direction; the restraint plates 8 sandwich and restrain the stacked body 2, the pair of current collector plates 5, and the pair of insulating plates 20 in the Z axis direction; and the terminal base 70 having the terminal bolt 32 electrically connected to the terminal of the current collector plate 5 and protruding in the Y axis direction fixed thereto, and provided on the side surface 8a extending in the X axis direction and the Z axis direction in the restraint plate 8. The restraint plate 8 has a pair of projecting portions 18 projecting in the Y axis direction beyond the side surface 8a having the terminal base 70 fixed thereto when viewed in the Z axis direction. The terminal base 70 is disposed between the pair of projecting portions 18 when viewed in the Z axis direction. The pair of projecting portions 18 projects beyond the terminal base protection portion 16 in the Y axis direction.

In the foregoing power storage device 1, the pair of insulating plates 20 are sandwiched by the restraint plates 8 in the Z axis direction. Further, in the Y axis direction (second direction), the projecting portions 18 formed in the restraint plate 8 project beyond the terminal base protection portion 16 in the Y axis direction, and this terminal base protection portion 16 is disposed between the pair of projecting portions 18. Due to such a constitution, an external force applied to the power storage device 1 in the Y axis direction or the X axis direction is likely to act on the pair of projecting portions 18, and the terminal base protection portion 16 is likely to be protected from an external force. For example, when the power storage device 1 comes into contact with a wall surface or the like by relatively moving in the Y axis direction, only the projecting portions 18 projecting in the Y axis direction come into contact with the wall surface or the like. In this case, damage to the terminal base protection portion 16 of the insulating plate 20 positioned between the pair of projecting portions 18 is curbed. In addition, when an object collides with the power storage device 1 in the X direction in the end portion in the Y axis direction, damage to the terminal base protection portion 16 positioned between the pair of projecting portions 18 is curbed. In the power storage device 1, since damage to the insulating plate 20 (terminal base protection portion 16) is curbed, deterioration in insulation properties between the bipolar electrodes and the restraint plates 8 can be curbed.

In the foregoing power storage device 1, in the end portion on the positive side in the Y axis direction, the liquid receiving portion 24C is disposed between the pair of projecting portions 18 when viewed in the Z axis direction, and the pair of projecting portions 18 project beyond the liquid receiving portion 24C in the Y axis direction. For this reason, since the pair of projecting portions also function as protection members on the positive side in the Y axis direction, damage to the liquid receiving portion 24C (insulating plate) is curbed.

The insulating plate 20 according to an example may have the wall portion 24 standing in the Z axis direction. The wall portion 24 may have the first wall portion 24A standing in a direction lying in the Z axis direction away from the restraint plate 8 adjacent thereto in a range having the projecting portions 18 formed therein in the X axis direction, and the second wall portion 24B standing in a direction opposite to the first wall portion 24A in the Z axis direction in a range between the pair of projecting portions 18 in the X axis direction. In this constitution, accumulation of a liquid on the inward side of the wall portion 24 formed in the insulating plate 20 is curbed.

The first wall portion 24A according to an example has the side wall 25a in the X axis direction when viewed in the Z axis direction. The pair of projecting portions 18 may project beyond the side wall 25a in the Y axis direction. In this constitution, for example, when the power storage device 1 comes into contact with the wall surface or the like by relatively moving in the Y axis direction, only the projecting portions 18 projecting in the Y axis direction come into contact with the wall surface or the like. In this case, damage to the side wall 25a further recessed than the projecting portions 18 in the Y axis direction is curbed.

The second wall portion 24B according to an example has the side wall 25c covering the side surface 8a in the X axis direction when viewed in the Z axis direction. The side wall 25a may project beyond the side wall 25c in the Y axis direction. In this constitution, the insulation distance between the current collector plate and the restraint plate 8 at the position of the side wall 25a can be lengthened as much as a projecting length of the side wall 25a.

The second wall portion 24B according to an example has the side walls 25d in the Y axis direction when viewed in the Z axis direction such that the side surface 8b of the projecting portion 18 in the Y axis direction is covered. The side wall 25c and the side walls 25d may be connected to each other and cover the side surface 8a and the side surface 8b of the restraint plate 8. In this constitution, a liquid accumulated on the inward side of the wall portion 24 formed in the insulating plate 20 can be discharged along the side wall 25c and the side walls 25d.

Hereinabove, the embodiment has been described in detail with reference to the drawing. However, a specific constitution thereof is not limited to this embodiment.

An example in which the tip of the terminal bolt 32 in the Y axis direction positioned on the negative side in the Y axis direction from the side surfaces 8c of the projecting portions 18 has been described, but the tip of the terminal bolt 32 may be positioned on the positive side in the Y axis direction from the side surfaces of the projecting portions 18.

What is claimed is:

1. A power storage device comprising:
a stacked body configured to have a power storage module in which electrodes including a plurality of bipolar electrodes are stacked in a first direction;
a pair of current collector plates configured to be respectively stacked at both ends of the stacked body in the first direction;
a pair of insulating plates configured to sandwich the stacked body and the pair of current collector plates in the first direction;
a pair of restraint plates configured to sandwich and restrain the stacked body, the pair of current collector plates, and the pair of insulating plates in the first direction; and
a terminal base configured to have a terminal bolt electrically connected to a terminal of at least one of the current collector plates and protruding in a second direction intersecting the first direction fixed thereto, and be provided on a first side surface extending in a third direction intersecting both the first direction and the second direction, and the first direction in at least one of the restraint plates,
wherein the at least one of the restraint plates is configured to have a pair of projecting portions projecting in the second direction beyond the first side surface having the terminal base fixed thereto when viewed in the first direction,
wherein the terminal base is configured to be disposed between the pair of projecting portions when viewed in the first direction,
wherein at least one of the insulating plates is configured to include a terminal base protection portion covering at least a part of the terminal base, and
wherein the pair of projecting portions are configured to project beyond the terminal base protection portion in the second direction.

2. The power storage device according to claim 1,
wherein the at least one of the insulating plates is configured to have a peripheral wall standing in the first direction, and
wherein the peripheral wall is configured to have
a first wall portion standing in a direction lying in the first direction away from the at least one of the restraint plates adjacent thereto in a range having the projecting portions formed therein in the third direction, and
a second wall portion standing in a direction opposite to the first wall portion in the first direction in a range between the pair of projecting portions in the third direction.

3. The power storage device according to claim 2,
wherein the first wall portion is configured to have a first side wall in the third direction when viewed in the first direction, and
wherein the pair of projecting portions are configured to project beyond the first side wall in the second direction.

4. The power storage device according to claim 3,
wherein the second wall portion is configured to have a second side wall covering the first side surface in the third direction when viewed in the first direction, and
wherein the first side wall is configured to project beyond the second side wall in the second direction.

5. The power storage device according to claim 4,
wherein the second wall portion is configured to have a third side wall in the second direction when viewed in the first direction such that a second side surface in the second direction of the projecting portions is covered, and
wherein the second side wall and the third side wall are configured to be connected to each other and cover the first side surface and the second side surface of the at least one of the restraint plates.
